(19) United States
(12) Patent Application Publication
(10) Pub. No.: US 2016/0165343 A1
(43) Pub. Date: Jun. 9, 2016

(54) WIRELESS CONNECTION AND CONTROL METHOD FOR WIRELESS SOUND BOX AND SYSTEM THEREOF

(71) Applicant: JAZZ HIPSTER CORPORATION, New Taipei City (TW)

(72) Inventors: Yueh-Hua HSU HUANG, New Taipei City (TW); Shih-Chieh CHEN, New Taipei City (TW)

(21) Appl. No.: 14/560,991

(22) Filed: Dec. 4, 2014

(51) Int. Cl. H04R 3/00

(52) U.S. Cl. CPC H04R 3/00; H04R 2420/07

(57) ABSTRACT

A wireless connection and control method for wireless sound box and system thereof, comprising a control application installed in a mobile electronic device and a wireless sound box, such that, when a user starts the control application of the mobile electronic device, it is possible to input control instructions via an operation interface. Following this, the control application converts the transmission packet data represented by the control instruction into audio signals hardly interfered by human voice and perceptible by human ears in order to constitute an encrypted audio. On the other hand, upon receiving a played encrypted audio, the wireless sound box can execute the control instruction represented by the transmission packet data such that the mobile electronic device can perform wireless connection to the wireless sound box or the mobile electronic device can control the operations of the wireless sound box.

### BACKGROUND OF THE INVENTION

1. Field of the Invention

The present invention relates to a wireless connection and control method for wireless sound box and system thereof; in particular, it uses audio signals hardly interfered by human voice and perceptible by human ears so that the mobile electronic device can perform wireless connection to the wireless sound box or the mobile electronic device can control the operations of the wireless sound box.

2. Description of Related Art p The sound box is a kind of electronic apparatus capable of playing music for people to enjoy. With the development of wireless technology, wireless applications can now be extended to sound box devices as well; currently it is possible to install a built-in Bluetooth™ signal receiver within a common wireless sound box in order to set up peer-to-peer connection to the wireless sound box by means of the built-in Bluetooth™ connection function of a mobile phone.

However, in general, it is actually still very cumbersome to make wireless connection to a wireless sound box. Taking Bluetooth™ connection as an example, it is typically required to adjust the wireless sound box to a pairing mode, and then push a certain switch on the wireless sound box in a direction to an end for a few seconds, thus a Bluetooth™ indicator may rapidly blink which means it has been successfully switched into the pairing mode; in case it is a peer-to-peer connection with a mobile phone, a wireless sound box symbol may appear on the mobile phone at this moment and peer-to-peer connection can be achieved by clicking thereon.

Although at present most of the existing wireless sound boxes adopt the Bluetooth™ technology, currently available Bluetooth™ transmission technology usually operates in accordance with SBC encoding of A2DP stereo audio transmission protocol or CSR apt-X Hi-Fi audio compression technology to implement CD-leveled audio quality. However, all such technologies essentially need to perform compression processes on original audio files for further streaming transfers, so fidelity losses are inevitable. Hence, as audio formats evolve, Wi-Fi technology is more advantageous in satisfying high resolution music listening requirements, comparatively speaking. But, in operation, Wi-Fi connection may be even more complicated than Bluetooth™ connection.

Typically, for a wireless sound box capable of the Wi-Fi connection, it may comprise a built-in wireless network base station. In operation, it needs first to connect a personal computer to an LAN port of the wireless sound box by means of a network cable, or alternatively to the base station representing the wireless sound box through a wireless network (but the premise is the wireless network configuration has been already well set up); moreover, before use, it is also necessary to link to the administration interface of the wireless network base station in the wireless sound box and input required data such as wireless network name, wireless key/password settings etc. in order to ensure successful Wi-Fi operation mode. In addition to using the wireless sound box as a wireless base station, as previously described, another application mode concerns letting a mobile electronic device and a wireless sound box both connect to a wireless home network base station; but, in this approach, the wireless sound box still needs to learn the name of the wireless network base station to be linked to, wireless key/password or the like via complicated wired or wireless setup mode.

Accordingly, no matter which method is used to connect a wireless sound box to a Wi-Fi network, it is apparent from the aforementioned illustrations that operation difficulty and complexity to a certain extent does exist; consequently, for a user not familiar with relevant knowledge and skills, to successfully complete the Wi-Fi connection of a wireless sound box may become quite challenging. Therefore, to facilitate more convenient operations for general users in wireless connection of wireless sound box is a significant issue required to be resolved.

As such, it would be an optimal solution if a convenient method can be offered so that a user can easily operate a mobile phone to output an audio signal and, when received by a wireless sound box, the wireless sound box can decode it automatically based on the received audio signal so as to obtain the data needed during wireless connection setups or the instructions for controlling the wireless sound box.

### SUMMARY OF THE INVENTION

The present invention relates to a wireless connection and control method for wireless sound box and system thereof, which uses audio signals hardly interfered by human voice and perceptible by human ears in order that the mobile electronic device can perform wireless connection to the wireless sound box or the mobile electronic device can control the operations of the wireless sound box.

A wireless connection and control method for a wireless sound box capable of achieving the aforementioned objective is provided, comprising the following steps:

(1) after starting a control application on a mobile electronic device, the user inputs control instructions via an operation interface;

(2) the control application is capable of converting the transmission packet data represented by the control instructions into audio signals thereby constituting an encrypted audio, the frequency range of the converted audio signal being 10K˜20 KHz;

(3) upon a wireless sound box receiving the encrypted audio played by the mobile electronic device, the wireless sound box converts audio signals of the received encrypted audio into the transmission packet data;

(4) subsequently, the wireless sound box executes the control instructions represented by the transmission packet data such that the mobile electronic device can perform wireless connection to the wireless sound box or the mobile electronic device can control the operations of the wireless sound box.

More specifically, the transmission packet data represented by said control instructions further comprises a fixed signal sequence code, in which the wireless sound box stores the fixed signal sequence code and, with regards to the converted transmission packet data, determines preferentially whether the transmission packet data includes the fixed signal sequence code; if determined to be so, it continues analyses of the transmission packet data.

More specifically, the transmission packet data represented by said control instructions further comprises an error correction code, in which the error correction code is used to, when the wireless sound box determines that a complete transmission packet data may not be successfully converted, detect and correct the converted transmission packet data based on the error correction code.

More specifically, when the wireless sound box determines a complete transmission packet data can not be successfully converted, it can make string comparison on the transmission packet data in order to recover the transmission packet data the mobile electronic device intends to transfer.

More specifically, after said control application converts the transmission packet data represented by the control instructions into audio signals, it can mix a music signal with the converted audio signal in order to constitute an encrypted audio.

A wireless connection and control system for a wireless sound box according to the present invention, comprising: a control application installed in a mobile electronic device having a speaker and a wireless connection module, in which the control application includes a control instruction input interface, provided with an operation interface thereby allowing a user to input control instructions; a transmission packet data conversion module, connected to the control instruction input interface in order to convert the inputted control instructions into transmission packet data having several codes; a storage module, including a built-in reference table with code-corresponded audio signals; an audio signal conversion module, connected to the transmission packet data conversion module and the storage module, such that the control instruction conversion module converts all the codes within the transmission packet data into audio signals based on the built-in reference table of the storage module so as to constitute an encrypted audio, in which the frequency range of the converted audio signals is 10K˜20 KHz; an audio signal playing module, connected to the audio signal conversion module such that the audio signal playing module plays the encrypted audio by means of the speaker on the mobile electronic device; a wireless sound box, comprising: an audio signal reception module, used to receive the encrypted audio; a storage module, including a built-in reference table and a decoding table with code-corresponded audio signals; an audio signal decoding module, connected to the audio signal reception module so as to convert the audio signal of the received encrypted audio into transmission packet data having several codes based on the built-in reference table of the storage module; and a control instruction execution module, connected to the audio signal decoding module in order to analyze the transmission packet data converted by the audio signal decoding module and execute the control instruction represented by the transmission packet data, such that the mobile electronic device can perform wireless connection to the wireless sound box or the mobile electronic device can control the operations of the wireless sound box.

More specifically, the transmission packet data further comprises a fixed signal sequence code, in which the storage module of the wireless sound box stores the fixed signal sequence code and, with regards to the converted transmission packet data, the audio signal decoding module determines preferentially whether the transmission packet data includes the fixed signal sequence code; and it continues analyses of the transmission packet data only if the fixed signal sequence code is determined to be included therein.

More specifically, the format of the transmission packet data consists of at least a sync signal field, a channel coding field, a packet type field and a data content field, and the transmission packet data conversion module can, based on such different fields, enter the control instructions inputted by the user into different fields with different codes so as to constitute the transmission packet data.

More specifically, the sync signal field includes a fixed signal sequence code, and the audio signal conversion module converts first the code in the sync signal field into an audio signal and sets the playing sequence for the converted audio signal in the encrypted audio as precedence.

More specifically, different codes in the channel coding field represent whether different channel coding formats are enabled or disabled.

More specifically, different codes in the packet type field represent different operation modes.

More specifically, the format of the transmission packet data further includes an error correction field which has an error correction code, so that, when the audio signal decoding module determines that a complete transmission packet data may not be successfully converted, the audio signal decoding module uses the error correction code to detect and correct the converted transmission packet data based on the error correction code.

More specifically, after the audio signal conversion module converts all the codes within the transmission packet data into audio signals, it mixes an additional music signal with the code-converted audio signals in order to constitute an encrypted audio.

More specifically, the wireless sound box further comprises a wireless connection module connected to the control instruction execution module, and the wireless connection module allows the wireless sound box to make a wireless connection to the mobile electronic device, in which said wireless connection can be built by means of Bluetooth™ or Wi-Fi technologies.

More specifically, the wireless sound box further comprises an error detection module connected to the audio signal decoding module such that, in case the audio signal decoding module is unable to successfully convert the complete transmission packet data, it can make string comparison on the transmission packet data so as to recover the transmission packet data the mobile electronic device intends to transfer.

### BRIEF DESCRIPTION OF THE DRAWINGS

FIG. 1 shows a flowchart for the wireless connection and control of a wireless connection and control method for wireless sound box and system thereof according to the present invention.

FIG. 2 shows an integral preliminary diagram of a wireless connection and control method for wireless sound box and system thereof according to the present invention.

FIG. 3 shows an internal architecture diagram for the control application of a wireless connection and control method for wireless sound box and system thereof according to the present invention.

FIG. 4 shows a reference table for code-corresponded audio signals of a wireless connection and control method for wireless sound box and system thereof according to the present invention.

FIG. 5 shows a diagram of a first embodiment for the transmission packet data format of a wireless connection and control method for wireless sound box and system thereof according to the present invention.

FIG. 6 shows a diagram of a second embodiment for the transmission packet data format of a wireless connection and control method for wireless sound box and system thereof according to the present invention.

FIG. 7 shows an internal architecture diagram for the wireless sound box of a wireless connection and control method for wireless sound box and system thereof according to the present invention.

### DETAILED DESCRIPTION OF THE PREFERRED EMBODIMENTS

Other technical contents, aspects and effects in relation with the present invention can be clearly appreciated through the detailed descriptions concerning the preferred embodiments of the present invention in conjunction with the appended drawings.

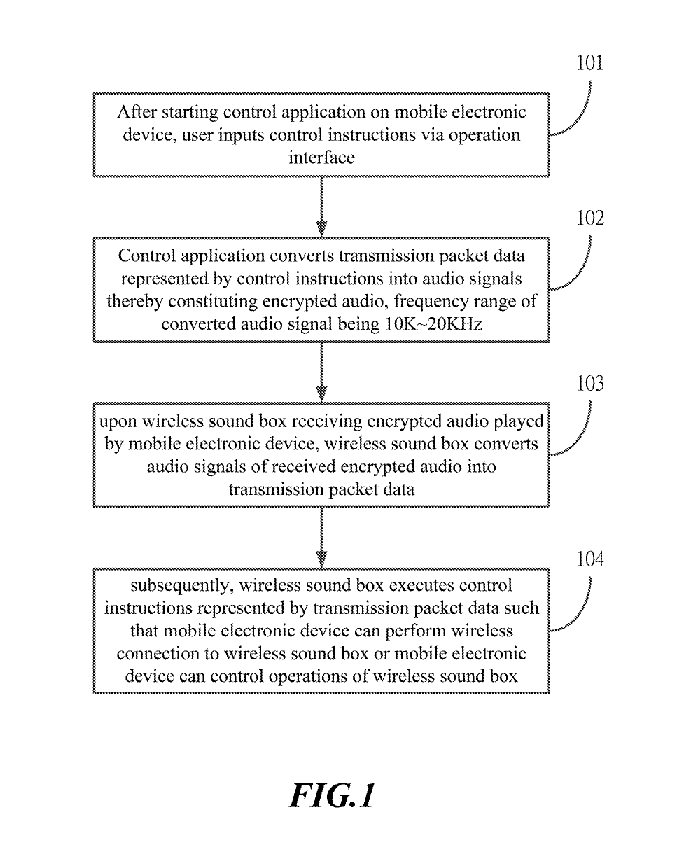

Refer initially to FIG. 1, wherein a flowchart for the wireless connection and control of a wireless connection and control method for wireless sound box and system thereof according to the present invention is shown, comprising the following steps:

1. after starting a control application on a mobile electronic device, the user inputs control instructions via an operation interface (101);

2. the control application is capable of converting the transmission packet data represented by the control instructions into audio signals thereby constituting an encrypted audio, the frequency range of the converted audio signal being 10K˜20 KHz (102);

3. upon a wireless sound box receiving the encrypted audio played by the mobile electronic device, the wireless sound box converts audio signals of the received encrypted audio into the transmission packet data (103);

4. subsequently, the wireless sound box executes the control instructions represented by the transmission packet data such that the mobile electronic device can perform wireless connection to the wireless sound box or the mobile electronic device can control the operations of the wireless sound box (104).

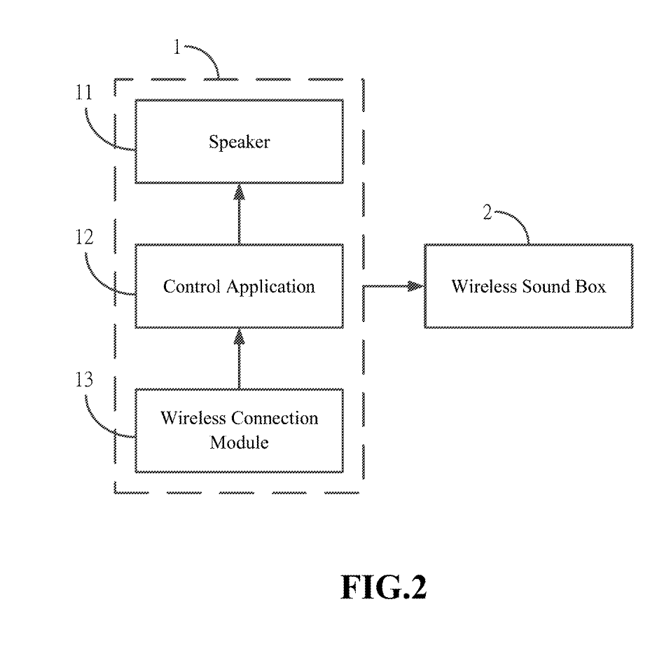

FIG. 2 shows an integral preliminary diagram of a wireless connection and control method for wireless sound box and system thereof according to the present invention. As shown in the Figure, the mobile electronic device 1 comprises a speaker 11, a control application 12 and a wireless connection module 13, wherein an encrypted audio can be generated by the control application 12 and then played by the speaker 11, so that the wireless sound box 2 can perform sound collections.

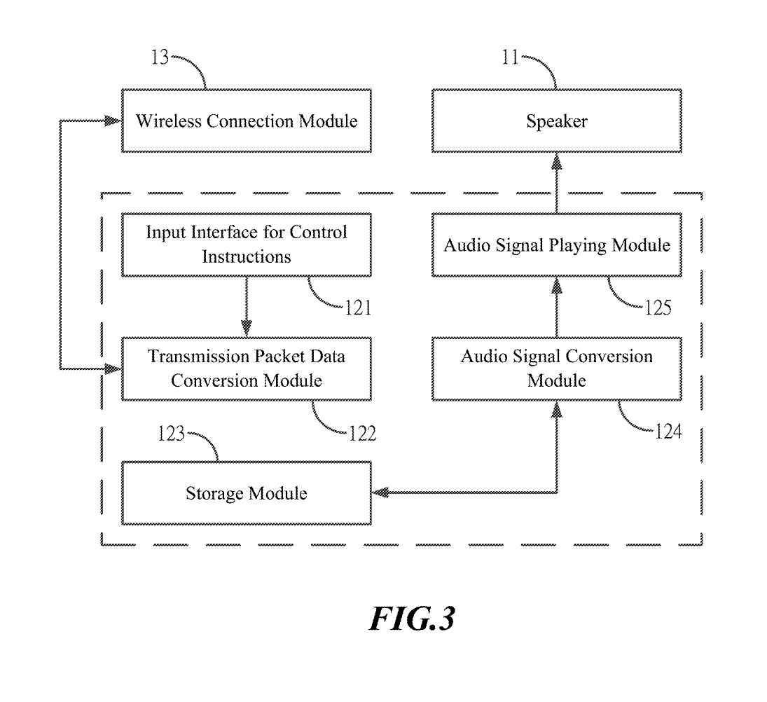

From FIG. 3 it can be seen that the control application 12 includes a control instruction input interface 121, a transmission packet data conversion module 122, a storage module 123, an audio signal conversion module 124 and an audio signal playing module 125. Herein the control instruction input interface 121 provides an operation interface thereby allowing a user to input control instructions. After the user having entered control instructions, the transmission packet data conversion module 122 converts the inputted control instructions, based on the contents thereof, into transmission packet data having several codes, wherein the format of the transmission packet data may consists of at least a sync signal field, a channel coding field, a packet type field as well as a data content field. Then the transmission packet data conversion module 122 can, in accordance with such different fields, enter the control instructions inputted by the user into different fields with different codes so as to constitute the transmission packet data.

Herein the sync signal field converts into 5 audio sequences, the channel coding field converts into 1 audio sequence the packet type field converts into 1 audio sequence, and the data content field converts into audio sequences of variable length based on the contents.

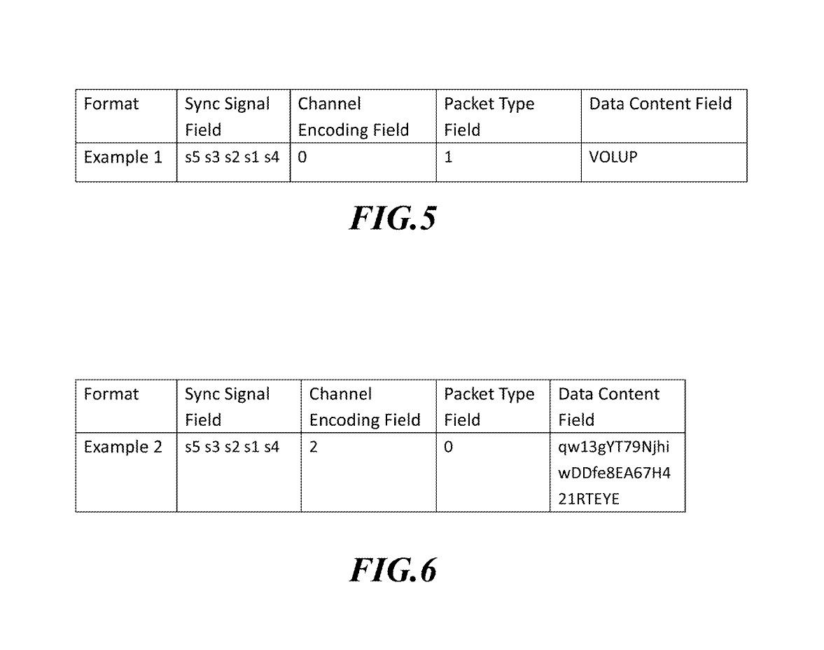

FIG. 5 and FIG. 6 respectively shows that the transmission packet data generated in accordance with different control instructions may vary. As illustrated in FIG. 5, when a user enters a control instruction via the operation interface in order to turn up the volume, then in this case, the sync signal field will be “s5 s3 s2 s1 s4”, the channel coding field “0”, the packet type field “1” and the data content field “VOLUP”. Herein the contents in the sync signal field indicate a fixed signal sequence code (used to perform signal analyses only when a signal sequence conforming to the format is received); different codes in the channel coding field indicate enabling different channel coding formats (“0” represents DISABLING channel coding format, “1” ENABLING channel coding format 1, “2” ENABLING channel coding format 2, “3” ENABLING channel coding format 3, while “4”˜“9” for reserved function); the contents in the packet type field stand for different operation modes (“0” represents SET mode, “1” CONTROL mode, “2”˜“9” for reserved function); and the data content field mainly holds the contents of the control instruction and the customized string defined in accordance with the function.

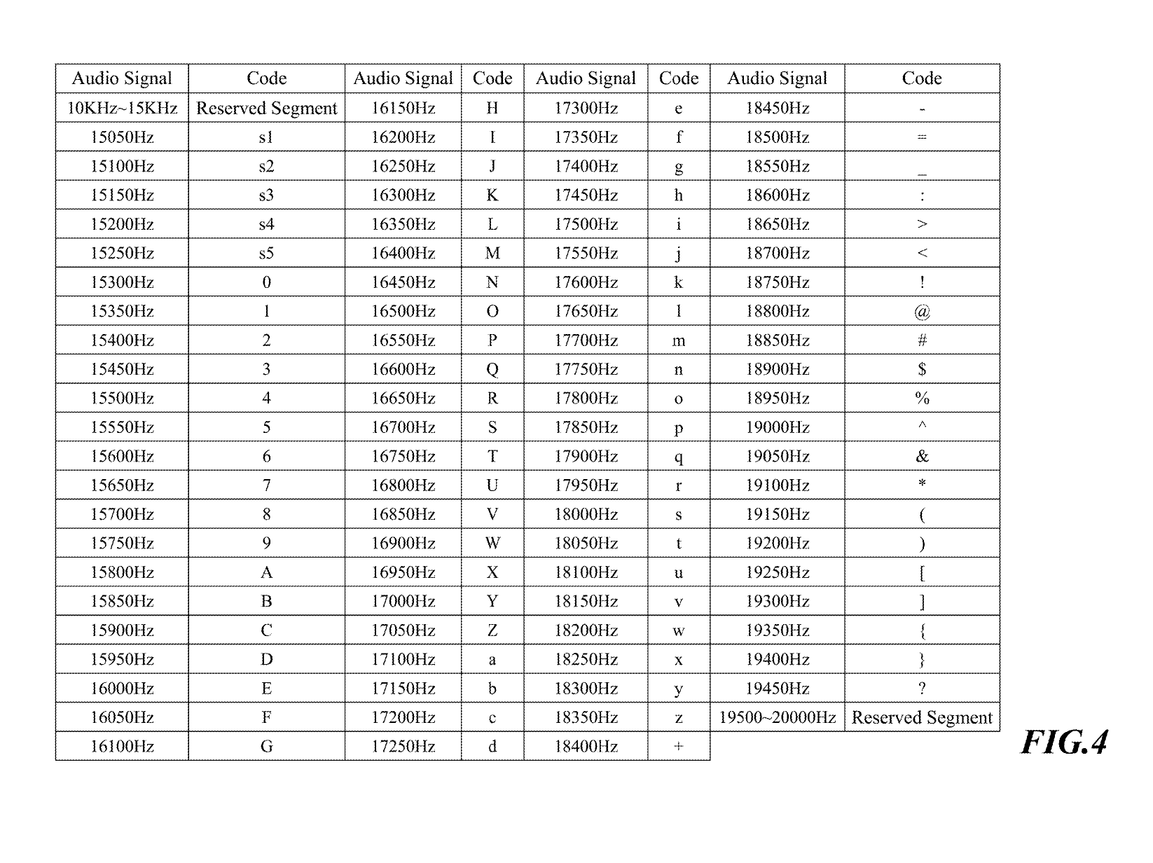

When the transmission packet data conversion module 122 has completed such code conversions in the transmission packet data based on the inputted control instruction, the audio signal conversion module 124 then converts sequentially each code into audio signals in accordance with the built-in reference table (as shown in FIG. 4) within the storage module 123. Taking the sync signal field as an example, it converts “s5 s3 s2 s1 s4” into five audio signals “15250 Hz 15150 Hz 15100 Hz 15050 Hz 15200 Hz”; or, for the data content field, the contents “VOLUP” will be converted into five audio signals “16850 Hz 16500 Hz 16350 Hz 16800 Hz 16550 Hz”. Then, all the audio signals converted from the sync signal field, the channel coding field, the packet type field and the data content field are continuously joined into an encrypted audio (in which the frequency range of the converted audio signals is 10K˜20 KHz), and the time interval between each audio signal can be also adjustable. When such operations are completed, through the audio signal playing module 125, the encrypted audio can be played by means of the speaker 11 on the mobile electronic device 1 (moreover, after converting all the codes in the transmission packet data by the audio signal conversion module 124, it is possible to further select an additional music signal in the mobile electronic device 1 so as to be mixed with the code-converted audio signals thereby forming an encrypted audio).

FIG. 6 illustrates a second set of transmission packet data format, wherein, when a user inputs a control instruction via the operation interface to set WI-FI connection data, the sync signal field is “s5 s3 s2 s1 s4”, the channel coding field “2”, the packet type field “0” and the data content field “qw13gYT79NjhiwDDfe8EA67H421RTEYE”, and since the data content field holds encrypted contents, when the audio signal playing module 125 plays the encrypted audio by means of the speaker 11 on the mobile electronic device 1, the wireless sound box 2 can acquire the encrypted audio through sound collections.

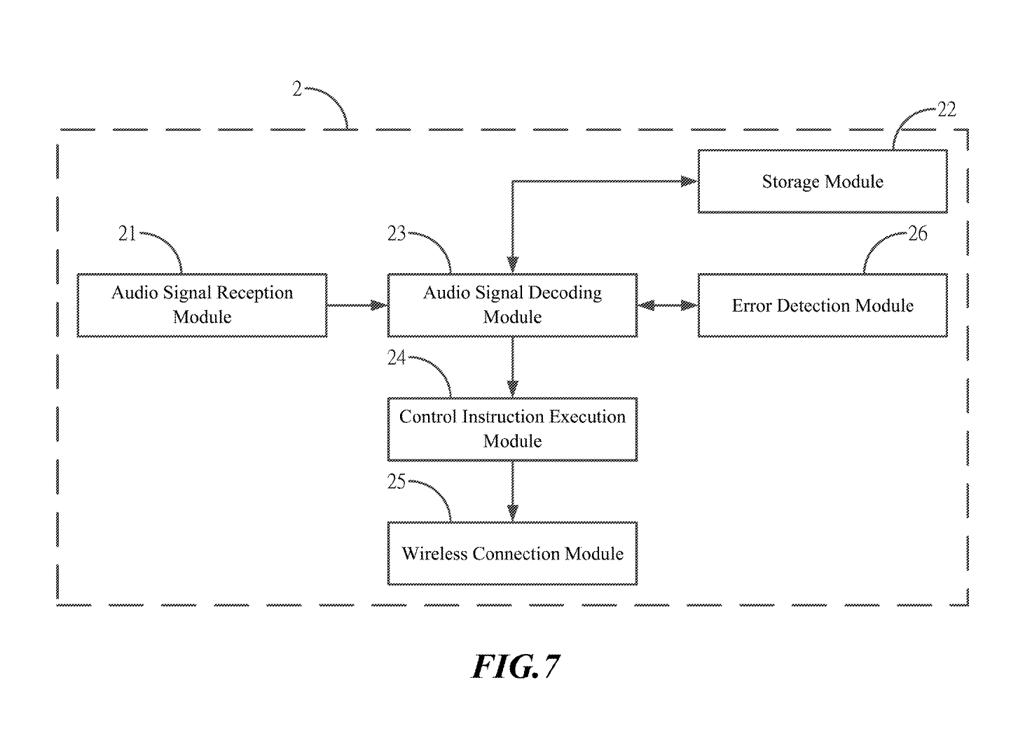

From FIG. 7, it can be seen that the wireless sound box 2 comprises an audio signal reception module 21, a storage module 22, an audio signal decoding module 23, a control instruction execution module 24, a wireless connection module 25 and an error detection module 26, wherein the audio signal reception module 21 can operate to receive the encrypted audio and the storage module 22 includes built-in reference table for code-corresponded audio signals, fixed signal sequence codes, decoding table and name correspondence table, such that the audio signal decoding module 23 can convert the received encrypted audio into the transmission packet data having several codes in accordance with the built-in reference table of the storage module.

Besides, with regards to the converted transmission packet data, the audio signal decoding module 23 will determine preferentially whether the fixed signal sequence code exists in the transmission packet data, and analyses on the transmission packet data will continue only if it is determined to be so. Taking the embodiment shown in FIG. 6 as an example, when the audio signal decoding module 23 first converts the audio signal to be the contents “s5 s3 s2 s1 s4” which is determined to be identical to the fixed signal sequence code stored in the storage module 22, so it continues audio signal conversion on the channel coding field to be “2” thus determining to enable channel coding format 2.

Following this, it further performs audio signal conversion on the packet type field to be “0” and determines this indicates the SET mode, then performs audio signal conversion on the data content field to be “qw13gYT79NjhiwDDfe8EA67H421RTEYE”, and, due to encryption, it needs to further decode “qw13gYT79NjhiwDDfe8EA67H421RTEYE” to derive a string “ws:JAZZ wp:12345678”, so the wireless sound box 2 now appreciates that the SSID for WIFI connection is “JAZZ” and PIN thereof is “12345678” (herein “ws” represents SSID and “wp” for PIN, which have been defined in the name correspondence table). Therefore, the wireless sound box 2 can analyze the transmission packet data acquired by the audio signal decoding module 23 through the control instruction execution module 24 and execute the control instruction represented by the transmission packet data such that the mobile electronic device 1 can make wireless connection to the wireless sound box 2 (or otherwise the mobile electronic device 1 can control operations of the wireless sound box 2).

Moreover, since the frequency range of the converted audio signal in the present invention is within 10K˜20 KHz, this frequency range in general can be hardly perceived by human ears and generated with human voice, thus mainly preventing interferences to the emitted encrypted audio due to human voice. However, in case errors still occur in the encrypted audio because of environmental sound interferences, the present invention provides the following two ways to address this issue:

(1) The wireless sound box 2 may comprise an error detection module 26 which can operate when the audio signal decoding module 23 is unable to recover the complete transmission packet data. For example, if the mobile electronic device 1 intends to send the name of the wireless network base station (CHT45238) to the wireless sound box 2, but the audio signal decoding module 23 can only resolve “C_T_5_38” out of it, then the wireless sound box 2 may begin to search in surrounding network environment and find e.g., “CHT45238” and “CHT23156”, so the error detection module 26 can utilize Longest Common Subsequence algorithm to string compare the acquired transmission packet data “C_T_5_38” with “CHT45238” and “CHT23156”, thus concluding higher similarity does exist between “CHT45238” and “C_T_5_38” and consequently using “CHT45238” to recover “C_T_5_38”.

(2) However, without such strings to compare, it is also possible that the format of the transmission packet data may further include an error correction field which has an error correction code, so that, when the audio signal decoding module 23 determines that a complete transmission packet data may not be successfully converted, the audio signal decoding module 23 can use the error correction code to detect and correct the converted transmission packet data based on the error correction code.

Compared with other prior arts, the wireless connection and control method for wireless sound box and system thereof according to the present invention provides the following advantages:

(1) The present invention allows a user to operate a mobile phone to output an audio signal, then the wireless sound box performs sound collections and decodes automatically based on the received audio signals thereby obtaining the data required for wireless connection or instructions for controlling the wireless sound box.

(2) The present invention uses audio signals hardly interfered by human voice and perceptible by human ears so that a mobile electronic device can make wireless connection to the wireless sound box or control the operations of the wireless sound box.

Although the present invention has been disclosed through the detailed descriptions of the aforementioned embodiments, such illustrations are by no means used to restrict the present invention. Skilled ones in relevant fields of the present invention can certainly devise any applicable alternations and modifications after comprehending the aforementioned technical characteristics and embodiments of the present invention without departing from the spirit and scope thereof. Hence, the scope of the present invention to be protected under patent laws should be delineated in accordance with the claims set forth hereunder in the present specification.

What is claimed is:

1. A wireless connection and control method for a wireless sound box, the method comprising:
after starting a control application on a mobile electronic device, the user inputs control instructions via an operation interface;
the control application converts the transmission packet data represented by the control instructions into audio signals thereby constituting an encrypted audio, the frequency range of the converted audio signal being 10K˜20 KHz;
upon a wireless sound box receiving the encrypted audio played by the mobile electronic device, the wireless sound box converts audio signals of the received encrypted audio into the transmission packet data;
subsequently, the wireless sound box executes the control instructions represented by the transmission packet data such that the mobile electronic device can perform wireless connection to the wireless sound box or the mobile electronic device can control the operations of the wireless sound box.

2. The wireless connection and control method for a wireless sound box according to claim 1, wherein the transmission packet data represented by the control instructions further comprises a fixed signal sequence code, in which the wireless sound box stores the fixed signal sequence code and, with regards to the converted transmission packet data, determines preferentially whether the transmission packet data includes the fixed signal sequence code; if determined to be so, it continues analyses of the transmission packet data.

3. The wireless connection and control method for a wireless sound box according to claim 1, wherein the transmission packet data represented by the control instructions further comprises an error correction code, in which the error correction code is used to, when the wireless sound box determines that a complete transmission packet data may not be successfully converted, detect and correct the converted transmission packet data based on the error correction code.

4. The wireless connection and control method for a wireless sound box according to claim 1, wherein, when the wireless sound box determines a complete transmission packet data may not be successfully converted, it can make string comparison on the transmission packet data in order to recover the transmission packet data the mobile electronic device intends to transfer.

5. The wireless connection and control method for a wireless sound box according to claim 1, wherein, after the control application converts the transmission packet data represented by the control instructions into audio signals, it can mix a music signal with the converted audio signal in order to constitute an encrypted audio.

6. A wireless connection and control system for a wireless sound box, comprising:
a control application installed in a mobile electronic device having a speaker and a wireless connection module, in which the control application includes:
a control instruction input interface, provided with an operation interface thereby allowing a user to input control instructions;
a transmission packet data conversion module, connected to the control instruction input interface in order to convert the inputted control instructions into transmission packet data having several codes;
a storage module, including a built-in reference table with code-corresponded audio signals;
an audio signal conversion module, connected to the transmission packet data conversion module and the storage module, such that the control instruction conversion module converts all the codes within the transmission packet data into audio signals based on the built-in reference table of the storage module so as to constitute an encrypted audio, in which the frequency range of the converted audio signals is 10K˜20 KHz;
an audio signal playing module, connected to the audio signal conversion module such that the audio signal playing module plays the encrypted audio by means of the speaker on the mobile electronic device;
a wireless sound box, comprising:
an audio signal reception module, used to receive the encrypted audio;
a storage module, including a built-in reference table and a decoding table with code-corresponded audio signals;
an audio signal decoding module, connected to the audio signal reception module so as to convert the audio signal of the received encrypted audio into transmission packet data having several codes based on the built-in reference table of the storage module; and
a control instruction execution module, connected to the audio signal decoding module in order to analyze the transmission packet data converted by the audio signal decoding module and execute the control instruction represented by the transmission packet data, such that the mobile electronic device can perform wireless connection to the wireless sound box or the mobile electronic device can control the operations of the wireless sound box.

7. The wireless connection and control system for a wireless sound box according to claim 6, wherein the transmission packet data further comprises a fixed signal sequence code, in which the storage module of the wireless sound box stores the fixed signal sequence code and, with regards to the converted transmission packet data, the audio signal decoding module determines preferentially whether the transmission packet data includes the fixed signal sequence code; and it continues analyses of the transmission packet data only if the fixed signal sequence code is determined to be included therein.

8. The wireless connection and control system for a wireless sound box according to claim 6, wherein the format of the transmission packet data consists of at least a sync signal field, a channel coding field, a packet type field and a data content field, and the transmission packet data conversion module can, based on such different fields, enter the control instructions inputted by the user into different fields with different codes so as to constitute the transmission packet data.

9. The wireless connection and control system for a wireless sound box according to claim 8, wherein the sync signal field includes a fixed signal sequence code, and the audio signal conversion module converts first the code in the sync signal field into an audio signal and sets the playing sequence for the converted audio signal in the encrypted audio as precedence.

10. The wireless connection and control system for a wireless sound box according to claim 8, wherein different codes in the channel coding field represent whether different channel coding formats are enabled or disabled.

11. The wireless connection and control system for a wireless sound box according to claim 8, wherein different codes in the packet type field represent different operation modes.

12. The wireless connection and control system for a wireless sound box according to claim 8, wherein the format of the transmission packet data further includes an error correction field which has an error correction code, so that, when the audio signal decoding module determines that a complete transmission packet data may not be successfully converted, the audio signal decoding module uses the error correction code to detect and correct the converted transmission packet data based on the error correction code.

13. The wireless connection and control system for a wireless sound box according to claim 6, wherein, after the audio signal conversion module converts all the codes within the transmission packet data into audio signals, it mixes an additional music signal with the code-converted audio signals in order to constitute an encrypted audio.

14. The wireless connection and control system for a wireless sound box according to claim 6, wherein the wireless sound box further comprises a wireless connection module connected to the control instruction execution module, and the wireless connection module allows the wireless sound box to make a wireless connection to the mobile electronic device, in which said wireless connection can be built by means of Bluetooth™ or Wi-Fi technologies.

15. The wireless connection and control system for a wireless sound box according to claim 6, wherein the wireless sound box further comprises an error detection module connected to the audio signal decoding module such that, in case the audio signal decoding module is unable to successfully convert the complete transmission packet data, it can make string comparison on the transmission packet data so as to recover the transmission packet data the mobile electronic device intends to transfer.
